(19) United States
(12) Patent Application Publication
(10) Pub. No.: US 2024/0381458 A1
(43) Pub. Date: Nov. 14, 2024

(54) NETWORK SEGMENTATION USING REGIONS

(71) Applicant: Ruckus IP Holdings LLC, Claremont, NC (US)

(72) Inventors: Sridhar Malarouthu, Pleasanton, CA (US); Renjith Kumar Ponnappan, Fremont, CA (US); Gefan Zhang, San Jose, CA (US); Inigo Arockia Nirmal Nevis, San Jose, CA (US); Arijit Bhattacharyya, San Jose, CA (US); Gajendra Shukla, San Jose, CA (US); Gowrishankar Mandagradala, Cupertino, CA (US)

(21) Appl. No.: 18/660,583

(22) Filed: May 10, 2024

Related U.S. Application Data
(60) Provisional application No. 63/465,993, filed on May 12, 2023.

(51) Int. Cl. H04W 76/12; H04W 12/06; H04W 84/10

(52) U.S. Cl. CPC H04W 76/12; H04W 12/06; H04W 84/10

(57) ABSTRACT

Segmenting personal area networks (PAN) in a computer network using regions, which may include: associating a first client device to a first PAN, where the first PAN is assigned to a first region from a plurality of regions; receiving an indication that the first client device is in communication with a first computer networking device; identifying whether the first computer networking device is a member of a plurality of computer networking devices that service the first region; selecting one of a first identifier or a second identifier based on whether the first computer networking device is or is not a member of the plurality of computer networking devices; and communicating the selected one of the first identifier and the second identifier to the first computer networking device. The first computer networking device may be configured to tag PAN network traffic from the first client device using the provided identifier.

### CROSS-REFERENCE TO RELATED APPLICATION

The present application claims the benefit of priority to U.S. Provisional Application No. 63/465,882, filed on May 12, 2023, and the entire contents of the above-identified application are incorporated by reference as if set forth herein.

### TECHNICAL FIELD

Aspects of the present disclosure relate to computer networks and computer networking devices, and in particular relate to providing segmentation and directing of traffic within computer networks using regions.

### BACKGROUND

Network connectivity to one or more computer networks (such as the Internet) is increasingly viewed as a “must-have” amenity for individuals and organizations when selecting a residence, business location, hotel, restaurant, and so on. Extensive networks are now nearly ubiquitous within hotels, apartment complexes, dormitory buildings, campuses, and elsewhere. Network connectivity in these and other locations can be provided with both wireless and wired connections. For example, many electronic devices communicate via wireless local area networks (WLANs) using an IEEE 802.11-compatible communication protocol (which is sometimes collectively referred to as ‘Wi-Fi’ or ‘WiFi’). Wired connections using, e.g., IEEE 802.3 (‘Ethernet’) are also often provided.

Increasingly, property owners and/or managers that provide space for multiple residents, tenants, guests, and so on are interested in making a single network available for use by multiple unrelated entities. For example, a hotel or apartment building may make a single wired and/or wireless network available to its collective group of guests or tenants, or an office building may offer access to a common wired and/or wireless network to each of its lessees. A single network not only provides a marketable amenity, but also may increase throughput and reduce interference for example because different networks are not competing for limited resources, such as available WiFi channels. Examples of such properties may be hereinafter referred to as multiple dwelling unit (MDU) properties, and the user or group of users associated with a single unit may be referred to as a “tenant.” The wired and/or wireless network offered at an MDU property may be hereinafter referred to as a MDU network. Note that some MDU properties and locations may have a variety of space offerings (e.g., retail space and/or a restaurant on a ground floor, hotel rooms on middle floors, and apartments on upper floors), none of which or not all of which may be “dwellings” (e.g., none of the units or not all of the units in a MDU may be a residence or a place of lodging). College or university dormitories may be one MDU network or tenant, and other kinds of “tenants” in higher education may include individuals or teams such as faculty, staff members, academic departments, administrative departments, laboratory facilities, etc. Thus, in various settings (e.g., corporate settings, academic settings), a “tenant” may encompass any individual or group that would benefit from secure access to networked resources.

In a common use case, a MDU tenant may desire to connect their network-enabled laptop or other ‘client device’ to the MDU network in order to access an Internet resource (such as a website). To do so, the user may configure the network-enabled laptop to connect to the MDU network via a wireless or wired connection. For example, in order to authenticate the client device and/or the user thereof, and in order to secure communications between the network and the client device, the user may enter (or the client device may obtain) a passphrase, such as a dynamic pre-shared key or DPSK.

Client devices may include computers, laptops, tablets, smartphones, printers, gaming devices, televisions, customer premises equipment, gateways, cable boxes, and other devices. Increasing proliferation of such client devices means that a tenant may desire to internetwork two or more of their electronic devices. For example, a tenant may desire that their network-enabled laptop intercommunicate with their network-enabled printer.

To provide privacy and security, the MDU network may be segmented, and each tenant on the MDU property may be provided with a “Personal Area Network” (PAN) (sometimes called a segment) to which their wired and wireless devices, and only their wired and wireless devices, can intercommunicate throughout the MDU property. For instance, the network-enabled laptop of the tenant can connect to the PAN of the tenant and be able to see the network-enabled printer that is also connected to the PAN and send a file to the printer over the MDU network for printing.

Connecting with a PAN may be independent of any particular wired physical connection or wireless network access point. Thus, for instance, a tenant may have multiple devices that connect to the MDU network and that are able to see and intercommunicate with each other, even if the devices are connected to the MDU network via different physical connections (e.g., different Ethernet ports, different wireless access points). This means that the tenant can connect to their devices and gain access to their PAN anywhere on the defined MDU property at any access or connection point or infrastructure. As an example, an individual may move throughout the MDU (e.g., a user may move from their apartment or hotel room to a restaurant or conference center) and not only have their client device remain connected to the MDU network, but also have their client device remain in communication with their PAN-connected devices connected to the MDU network located elsewhere in the MDU.

### SUMMARY

According to some aspects of the present disclosure, a method may include establishing a wireless connection between an access point and a client device, where the access point is configured to service a first region from a plurality of regions; identifying, by the access point, that the client device is a member of a first personal area network (PAN) associated with a second region from the plurality of regions; establishing, by the access point and in response to the identifying, a network tunnel between the access point and a gateway device; and communicating first PAN traffic for the client device via the established network tunnel.

According to some aspects of the present disclosure, a method associating a first client device with a first personal area network (PAN), wherein the first PAN is assigned to a first region from a plurality of regions; detecting that the first client device is in communication with a computer networking device that services a second region from the plurality of regions; establishing a tunnel between the computer networking device that services the second region and a network edge device; and transmitting, via the established tunnel, first PAN network traffic received at the network edge device and directed to the first client device.

According to some aspects of the present disclosure, a method may include associating a first client device to a first personal area network (PAN), wherein the first PAN is assigned to a first region from a plurality of regions; receiving an indication that the first client device is in communication with a first computer networking device; identifying whether the first computer networking device is a member of a plurality of computer networking devices that service the first region; selecting one of a first identifier or a second identifier, wherein the first identifier is selected in response to identifying that the first computer networking device is a member of the plurality of computer networking devices, and wherein the second identifier is selected in response to identifying that the first computer networking device provides service to a second region different than the first region; and communicating the selected one of the first identifier and the second identifier to the first computer networking device, wherein the first computer networking device is configured to tag PAN network traffic from the first client device using the communicated selected one of the first identifier and the second identifier.

### BRIEF DESCRIPTION OF THE DRAWINGS

FIG. 1 is a block diagram illustrating electronic devices and computer networking devices in a network according to some embodiments of the present disclosure.

FIG. 2 is a block diagram illustrating how all traffic in a network can be tunneled to a network edge device, providing segmentation.

FIG. 3 is a block diagram illustrating how a network (e.g., a MDU network) can be partitioned into regions.

FIGS. 4A to 4D are block diagrams illustrating how traffic can be selectively switched locally or tunneled to a network edge device, providing segmentation in a MDU network.

FIGS. 5A and 5B are communication flow diagrams illustrating how a computer networking device may identify whether a client device serviced by the computer networking device is a local client device or remote client device and direct network traffic from the client device accordingly.

FIGS. 6A and 6B are block diagrams illustrating how traffic can be selectively switched locally or tunneled to a network edge device, providing segmentation in a MDU network.

FIG. 7 is a block diagram illustrating how traffic can be selectively switched locally or tunneled to a network edge device, providing segmentation in a MDU network.

FIG. 8A is a flowchart detailing operations in a method of identifying whether a client device serviced by a computer networking device is connected to a local region computer networking device or a remote region computer networking device.

FIG. 8B is a flowchart detailing operations in a method of identifying whether a client device serviced by a computer networking device is a local client device or remote client device and directing network traffic from the client device based on the identification.

FIGS. 9A and 9B are block diagrams illustrating how a PAN can be assigned to a region in an automated manner.

FIG. 10 is a flowchart detailing operations in a method of assigning a PAN to a region based on network usage details.

FIG. 11 is a block diagram of an electronic device (e.g., an access point or a client device) according to embodiments of the present disclosure.

Like reference numerals refer to corresponding parts throughout the drawings. Moreover, multiple instances of the same part may be designated by a common prefix separated from an instance number by a dash.

### DETAILED DESCRIPTION

As mentioned above, the client devices, network traffic, and the PAN of one tenant may be segmented, or hidden and/or private relative to all other tenants on the property who may use the MDU network. Internet traffic for one tenant may also be segmented from Internet traffic for other tenants. One way this segmentation is typically implemented is using Virtual Local Area Networks (VLANs), which is defined by the IEEE 802.1Q standard. Typically in a MDU, each tenant/PAN is associated with a VLAN identifier (id), which is a 12-bit identifier. Network traffic (in the form of Ethernet frames) received from a client device is tagged with the VLAN id that is associated with the tenant, either by an access point or a switch.

For example, the network (and one or more computing devices thereof) may maintain an association between client devices and tenants (a many-to-one association), and an association between tenants and VLANs (a one-to-one association). In greater detail, the association between client devices and tenants may be a correlation between an identifier of a client device (e.g., the Media Access Control (MAC) address of a client device) and an identifier of the tenant, which may be a VLAN identifier or a PAN identifier. In some situations, the identifier of the tenant may be or may be ascertained using authentication credentials (e.g., a group dynamic pre-shared key (DPSK) or username/password) that are used by the tenant in connecting a client device to the network. In some situations, the identifier of the client device may be provided to the network for association with the tenant as part of a device enrollment or onboarding process. Further discussion of the usage of identifiers and/or authentication credentials and the association thereof with client devices is found in e.g., U.S. application Ser. No. 17/976,212, the entire contents of which are incorporated by reference herein.

Although such VLAN-based segmentation provides effective isolation between tenants in the MDU network, there are drawbacks. The use of the 12-bit VLAN identifier means that there are only 4,096 (2¹²) such identifiers. Some of these identifiers are typically reserved in networks, for example for default and management purposes, reducing the number even further, and yielding on the order of ˜4000 available VLAN ids, which means at best ˜4000 available PANs. Moreover, the potential mobility of devices results in all ports of all switches within a switch network that services the MDU needing to be configured to carry traffic for all VLANs. Broadcast, unknown-unicast, and multicast (BUM) traffic for each VLAN thus propagates throughout the MDU network, effectively resulting in each switch discovering or learning MAC addresses for every client device in the network. If a large number of client devices are connected to the MDU network, the switches (particularly the access switches) may have a total available MAC address table size that is unable to accommodate the large number of client devices, resulting ultimately in a further limit on the number of different PANs and/or client devices that can be supported. Accordingly, the number of available PANs may be insufficient for medium and large-scale deployments, such as hotel and conference centers, office complexes, educational campuses, apartment complexes, and so on.

To address these scalability issues, some vendors have turned to the IEEE 802.1ad standard, which supports double VLAN tagging, providing a second 12-bit identifier (referred to as an outer tag in the IEEE 802.1ad standard) that can be used independently of the original (first) 12-bit identifier (an inner tag). Although this double VLAN tagging can produce ˜16.7 million combinations (4096 outer tag values×4096 inner tag values), many switches do not examine both tags, and instead forward Ethernet frames using only the outer VLAN tags. Some MDU network segmentation solutions use IEEE 802.1ad by using one outer tag VLAN for each building (e.g., a first building has a first outer VLAN tag, a second building has a second outer VLAN tag, and so on) and traffic within each building is segmented using the inner VLAN tag. Although this provides an increased amount of segmentation, the aforementioned solution does not support mobility between such buildings, eliminating a benefit of MDU networks.

Another way in which scalability has been provided in MDU networks is to tunnel all traffic from a downstream (logically closer to the client devices) switch and/or access point to an upstream (logically farther from the client device) network edge device or gateway device. A network edge device or gateway device, often referred to simply as a gateway, is a networking hardware device that acts as an interface between different networks, enabling communication between them. Because of its location, the network gateway device also serves as a most-upstream (e.g., logically farthest from the client devices) edge of the MDU network, and thus may provide a convenient location for a tunnel endpoint.

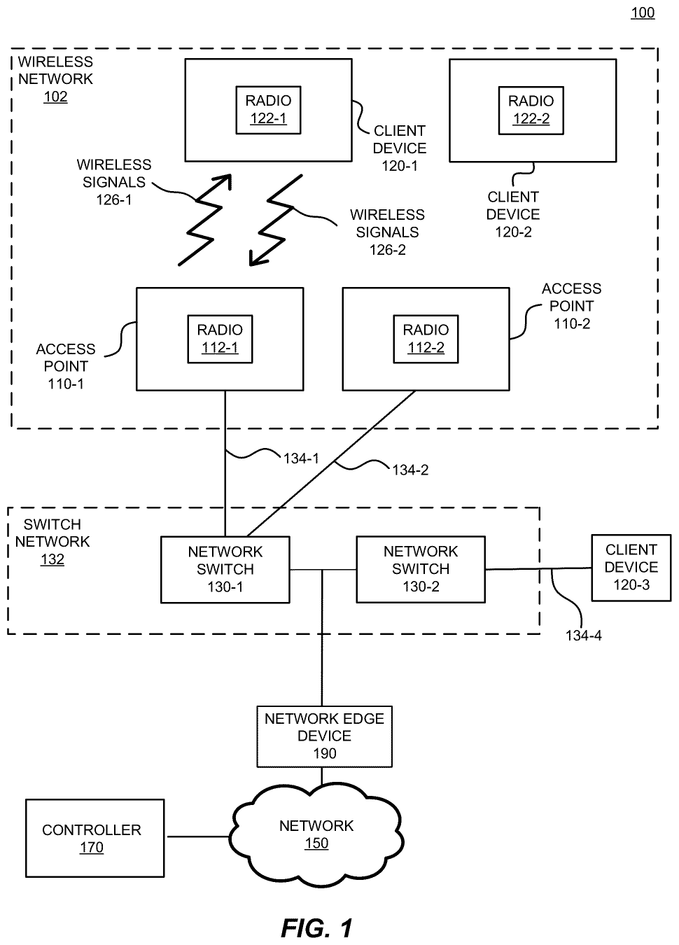

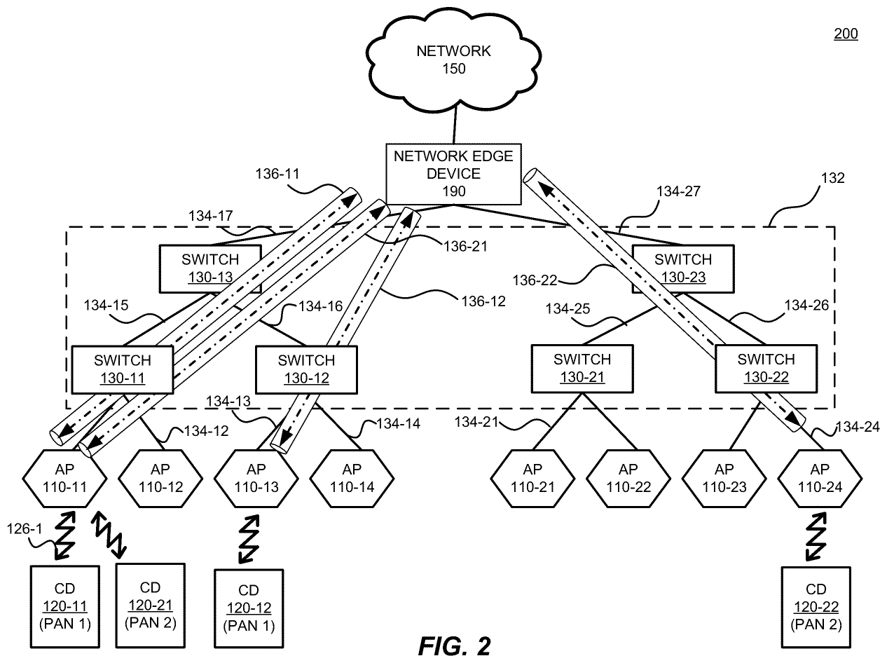

FIG. 1 is a block diagram illustrating electronic devices and computer networking devices in a network 100 according to some embodiments of the present disclosure. FIG. 2 is a block diagram illustrating how all traffic in a network 200 can be tunneled to a network edge device 190, providing segmentation.

Referring first to FIG. 1, in a network 100, one or more access points 110 may communicate with client devices 120 in a wireless network 102, which may be a wireless local area network (WLAN). The access points 110 may be serviced by a switch network 132 that includes one or more network switches and/or routers 130, which may facilitate access to a network (e.g., an external network) 150. The access points 110 and network switches and/or routers 130 may be referred to herein collectively as computer networking devices 110/130. The network 100 may also include other computer networking devices (not shown) such as data planes or the like.

The access points 110 may communicate using wireless and/or wired communication (such as by using Ethernet or a communication protocol that is compatible with Ethernet) with the client devices 120. Herein, wireless communication may include communication of packets or frames in accordance with a wireless communication protocol, such as an Institute of Electrical and Electronics Engineers (IEEE) 802.11 standard (sometimes referred to as ‘WiFi’. In the discussion that follows, WiFi is used as an illustrative example. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Other wireless interfaces and/or protocols may be used, such as Bluetooth, and unless stated otherwise, the present disclosure is not limited to a particular wireless communication standard, interface, or protocol.

In some embodiments, the access points 110 may include physical access points and/or virtual access points that are implemented in software in an environment of an electronic device or a computer. In some embodiments, the access points 110 may communicate with each other via wired or wireless connections (e.g., via the switch network 132 or via wireless signals 126). The wired and/or wireless communication among access points 110 in wireless network 102 may occur via a network (such as an intra-net, a mesh network, point-to-point connections and/or the Internet) and may use a network communication protocol, such as Ethernet. In some embodiments, the access points 110 may be arranged in a mesh configuration, such as where a direct wired or wireless connection between an access point 110 and a network switch 130 of the switch network 132 is absent, and the access point 110 instead communicates indirectly with the switch network 132 and/or the network 150 via an intermediate access point 110.

As can be seen in FIG. 1, wireless signals 126-1 (represented by a jagged line) are transmitted from a radio 112-1 in access point 110-1. These wireless signals may be received by radio 122-1 in a client device 120-1. Wireless signals 126-2 (represented by a jagged line) arc transmitted from the radio 122-1 in the client device 120-1. These wireless signals may be received by the radio 112-1 in the access point 110-1. Each of the radios 112 and 122 may be configured to generate and/or receive radio frequency signals in one or more wireless communication frequency bands (e.g., the 2.4 GHz frequency band, the 5 GHz frequency band, the 6 GHZ frequency band, and so on). Although only one radio 112/122 is shown in each of the access points 110 and client devices 120, it may be understood that in some embodiments multiple radios 112/122 may be present, each configured to generate and/or receive signals in different frequency bands.

Each of the client devices 120 may be, for example, any network-capable electronic device, including (as non-limiting examples) a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device. As seen in FIG. 1, some client devices 120 (e.g., client device 120-3) may not be part of the wireless network 102, and may instead be directly coupled with a network switch 130 of the switch network 132.

The switch network 132 may include one or more network switches and/or routers 130. In some embodiments, the one or more network switches and/or routers 130 may include a stack of multiple switches or routers (which are sometimes referred to as ‘stacking units’). As an example, a network switch 130-1 may include a number of communication interfaces or ports (not shown) in communication with one or more electronic devices. During operation, a first of the communication interfaces may receive a packet or other data container from a first electronic device (e.g., a client device 120, an access point 110, another networking switch 130). The packet may then be processed and forwarded to a second port associated with a second electronic device. The network switch and/or router 130 may be a layer-2 or layer-3 network switch or router. The switch network 132, and the network switches 130 thereof, may be coupled to access points 110 of the wireless network 102 via wired links 134.

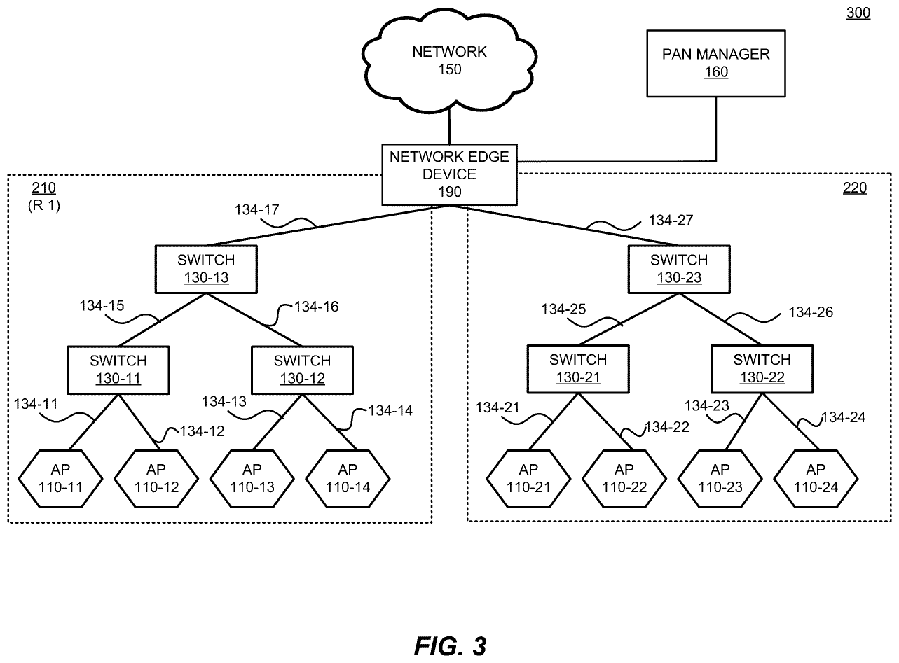

The controller 170 may be configured to perform configuration operations and/or management operations that control functionality of the computer networking devices 110/130. For example, the controller 170 may define flow definitions comprising packet processing rules and corresponding actions and promulgate these rules to the network switches 130 of the switch network 132. As another example, the controller 170 may manage the access points 110, for example by providing various configuration information, controlling settings, routing information, authorization/authentication information, or the like. The controller 170 may communicate with the access point 110 and/or network switches 130 via one or more logical links (not shown in FIG. 3), which in some embodiments may at least partially overlap the wired links 134. The controller 170 may be configured to offer a single user interface accessible via a web browser, command prompt, or the like, via which control commands may be entered.

In some embodiments, the controller 170 may be connected via physical links with one or more of the access points 110 or the network switches 130 (and may be part of the switch network 132). In some embodiments, the controller 170 may be one of the network switches 130. In some embodiments, the controller 170 may be a cloud-based controller 170 that may be operating at a location relatively remote from the switch network 132 and the network switches 130 thereof. The cloud-based controller 170 may communicate with the network switches 130 via a network, such as network 150.

The network 150 may be a layer-2 or layer-3 network, and may include one or more local area networks (LANs), campus area networks (CANs), wide area networks (WANs), metropolitan area networks (MANs), and/or the Internet. The network 150 may be separated from the switch network 132 by a network edge device 190, which may monitor network traffic that is incoming to and outgoing from the switch network 132 and decide whether to permit or prohibit various traffic based on one or more security rules. For example, the network edge device 190 may be or may include a firewall. The network 100 may be divided into an internal or premises network on a first side or edge of the network edge device 190 that includes the access points 110, client devices 120, switches/routers 130, wireless network 102, and switch network 132, and an external network (e.g., network 150) on a second or opposite side or edge of the network edge device 190. Although the controller 170 is shown on the second side of the network edge device 190, in some embodiments the controller 170 may be on the internal network on the first side of the network edge device 190 (e.g., the controller 170 may be an on-premises controller 170).

Although only one network edge device 190 and only one controller 170 are shown in FIG. 1, it is understood that in some embodiments, multiple network edge devices 190 and/or multiple controllers 170 may be provided, and that such devices may communicate with each other in order to manage all or part the network 100.

As seen in the example of FIG. 2, segmentation may be provided in some networks 200 by tunneling all PAN traffic to the network edge device 190. For example, client devices 120-11 and 120-12 associated with a first MDU tenant may be assigned to a first PAN (PAN 1), and client devices 120-21 and 120-22 associated with a second MDU tenant may be assigned to a second PAN (PAN 2). Traffic to and from client device 120-11 may be encapsulated in tunnel 136-11 between the access point 110-11 and the network edge device 190, and traffic to and from client device 120-12 may be encapsulated in tunnel 136-12 between the access point 110-13 and the network edge device 190. Accordingly, any traffic between the two client devices 120-11 and 120-12 of the first MDU tenant is via a path that includes the network edge device 190. Similarly, traffic to and from client device 120-21 may be encapsulated in tunnel 136-21 between the access point 110-11 and the network edge device 190, and traffic to and from client device 120-22 may be encapsulated in tunnel 136-22 between the access point 110-24 and the network edge device 190. Accordingly, any traffic between the two client devices 120-21 and 120-22 of the second MDU tenant is via a path that includes the network edge device 190.

One or more tunnel protocols can be used for each of the tunnels 136, such as, but not limited to: Ethernet over IP (EoIP), Generic Routing Encapsulation (GRE), a Virtual extensible Local Area Network (VXLAN), or another mobility tunnel technique or protocol. For example, if VXLAN is used, a 24-bit virtual network identifier (VNI) value can be used to identify each tunnel 136 and/or client device 120 and the network edge device 190 may associate the VNIs with PANs and direct traffic accordingly. The use of a 24-bit VNI enables support for ˜16.7 million client devices or tunnels, providing a solution to the scalability problems discussed above.

However, a drawback of the solution of FIG. 2 is that the network edge device 190, which is primarily intended to handle ‘north-south’ traffic into and out of the internal network now is involved in directing ‘east-west’ traffic within the internal network. This ‘east-west’ traffic can be directed more efficiently within the switch network 132 (e.g., via a path that does not include the network edge device 190). For example, if tunnelling were not used, PAN 1 traffic between the client devices 120-11 and 120-12 of the first MDU tenant could be switched ‘locally’ (within the switch network 132) via switches 130-11, 130-12, and 130-13, and the use of link 134-17 could be avoided. This ‘local’ switching also avoids use of computational resources of the network edge device 190. The solution of FIG. 2 does not scale well, because as the number of client devices 120 and tunnels 136 increases, the network edge device 190 must process an increasing amount of intra-network traffic, potentially limiting throughput and reducing functionality. Core links within the switch network 132 may also become saturated to the point of congestion.

Aspects of the present disclosure are directed to providing a network segmentation solution that supports a relatively large number of network segments or PANs, provides mobility throughout the MDU network, and optimizes switching within the switch network. In particular, aspects of the present disclosure include dividing a MDU premise into multiple smaller regions, with each region associated with and/or covering a smaller number of segments or PANs.

FIG. 3 is a block diagram illustrating how a network 300 (e.g., a MDU network) can be partitioned into regions, namely a first region 210 and a second region 220. For example, a large MDU complex may be divided into a plurality of regions, with each region encompassing one or more buildings of a multi-building complex. In another example, each region may be one or more floors of a building (or the only building) within the MDU. In yet another example, each region may be a different part of the MDU (e.g., a first region may be a hotel, a second region may be a conference center, a third region may be a shopping center, and so on). In some embodiments, the size of each region may be designed taking into account the MAC table sizes in the some or all of the switches 130 servicing the regions 210, 220. In some embodiments, the sizes of the regions 210, 220 may be different from each other.

Computer networking devices, such as access points 110 and switches 130, may be assigned and/or provided for each region and may provide service to the corresponding region. The computer networking devices that are assigned and/or provided to a region may be referred to herein as ‘members’ of the assigned-to region. In the example of FIG. 3, a first group of access points 110-11, 110-12, 110-13, and 110-14 are assigned to and service (e.g., are members of) the first region 210, and a second group of access points 110-21, 110-22, 110-23, and 110-24 are assigned to and service (e.g., are members of) the second region 220. Similarly, a first group of switches 130-11, 130-12, and 130-13 are members of the first region 210, and a second group of switches 130-21, 130-22, and 130-23 are members the second region 220.

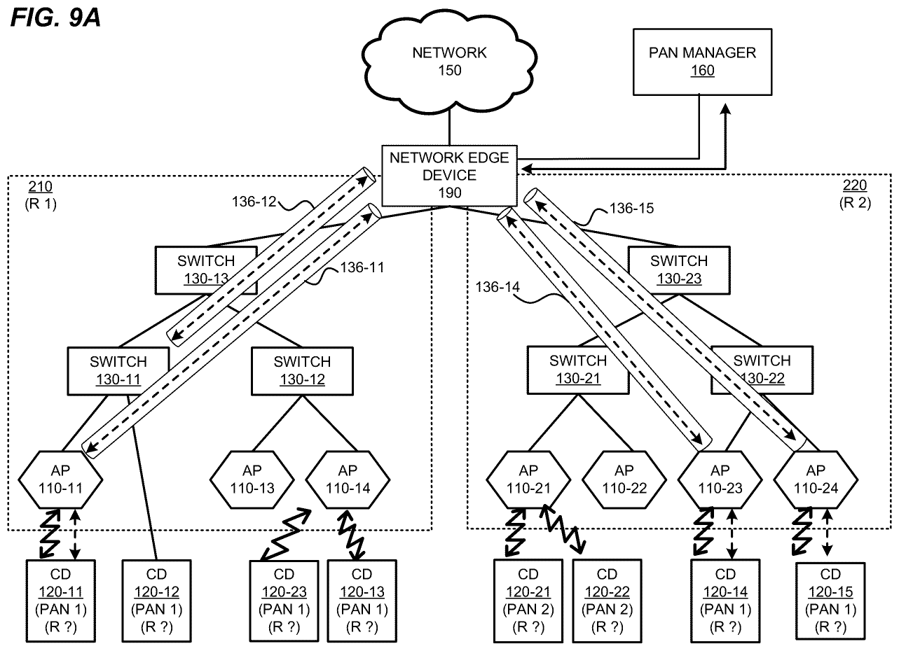

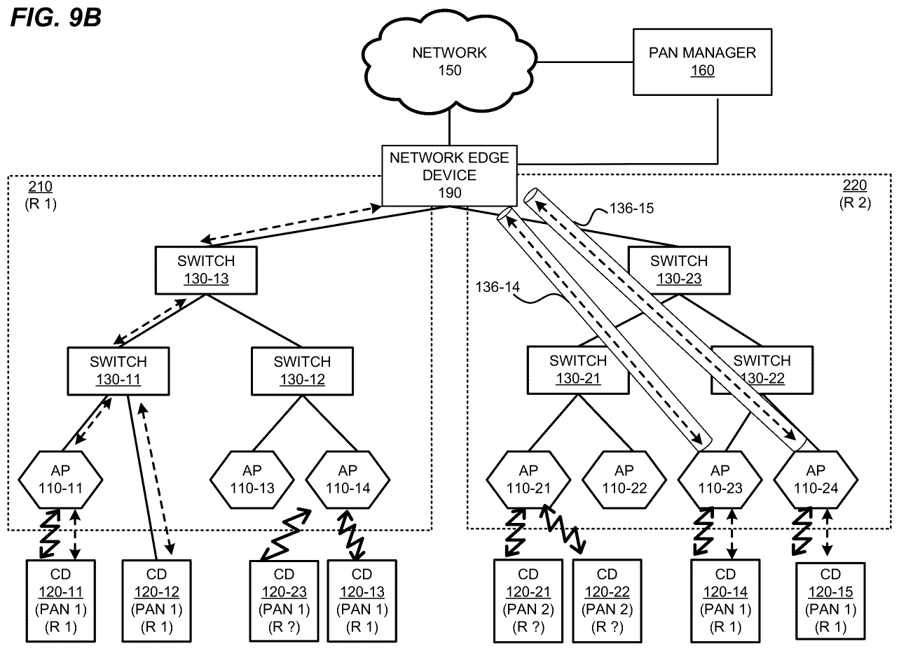

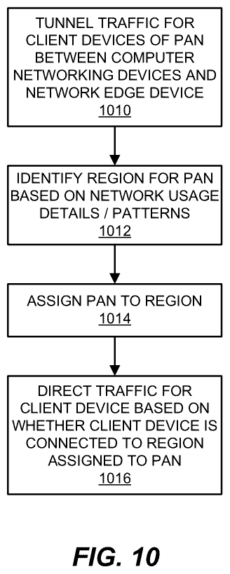

Each tenant, guest, resident, or the like of the MDU may be provided with a PAN, and the client devices 120 of the tenant may be associated with the PAN. The PAN for each tenant may be assigned to one of the regions in a manner that is discussed further below with respect to FIGS. 9A, 9B, and 10. In the figures, (R 1) is used to show client devices 120 that are associated with a PAN assigned to the first region 210, and (R 2) is used to show client devices that are associated with a PAN assigned to the second region 220. The region to which the PAN is assigned may be considered the ‘local’ region or ‘home’ region for the PAN. Conversely, the regions other than the local region to which the PAN is assigned may be considered to be ‘remote’ regions or ‘foreign regions’ for the PAN.

When a client device 120 is associated with a PAN and is connected to a computer networking device 110/130 that is a member of the region to which the PAN is assigned, the client device 120 may be considered to be connected to the local region or home region for the PAN (and the client device 120 may be considered to be connected to a local region). When a client device 120 is associated with a PAN and is connected to a computer networking device 110/130 that is a member of a different region than that to which the PAN is assigned, the client device 120 may be considered to be connected to a remote region or foreign region for the PAN (and the client device 120 may be considered to be connected to a remote region).

The computer networking devices 110 and 130 may be configured to use a first mechanism to direct and forward traffic associated with ‘local’ client devices 120 (i.e., client devices that are associated with a PAN that is assigned to the region serviced by the computer networking device 110/130), and may use a second mechanism to direct and forward traffic associated with ‘remote’ client devices 120 (i.e., client devices that are associated with a PAN that is assigned to a different region than that which is serviced by the network computing device 110/130). For example, traffic received at a computer networking device 110/130 from a local client device 120 may be directed within the switch network 132 via a mechanism that uses VLAN tagging. Traffic received at a computer networking device 110/130 from a remote client device 120 may be directed via a tunnel mechanism between the computer networking device 110/130 and a network edge device 190. The traffic from the remote client device may be tagged by the computer networking device 110/130 using a VNI or tunnel identifier.

The network edge device 190 may provide service to all regions in the MDU network, and accordingly the network edge device 190 may be considered to be a member of all regions in the MDU network. At least some inter-region traffic that is received at the network edge device 190 may be transitioned between the first and second mechanisms. For example, PAN traffic from a first client device 120 that is connected to a remote region may be received at the network edge device 190 for delivery to a second client device 120 that is connected to its local region. The network edge device 190 may receive the PAN traffic from a tunnel established across the computer networking devices 110/130 of the remote region on behalf of the first client device 120, and the network edge device 190 may insert a VLAN tag into the PAN traffic so that the computer networking devices 110/130 of the local region can direct the PAN traffic to the second client device 120.

Going in the other direction, PAN traffic from the second client device 120 that is connected to its local region may be VLAN tagged and received at the network edge device 190 for delivery to the first client device 120 that is connected to the remote region. The network edge device 190 may encapsulate the received traffic within the tunnel established across the computer networking devices 110/130 of the remote region on behalf of the first client device 120. In some situations, where both the origin and destination client devices 120 are connected to remote regions, traffic may be received at the network edge device 190 via a first tunnel and communicated by the network edge device 190 via a second tunnel.

The computer networking devices 110/130 and the network edge device 190 may consult a PAN manager 160 to identify whether a client device 120 connected thereto is a local client device or a remote client device. In some embodiments the PAN manager 160 may be associated with or implement an AAA server (an Authentication, Authorization, and Accounting) server and/or a Remote Authentication Dial-In User Service (RADIUS) server. The PAN manager 160 may be configured to receive authentication requests from the client devices 120 and/or the computer networking devices 110/130, verify credentials associated with the client devices 120, and send acceptance or rejection responses to the client devices 120 and/or the computer networking devices 110/130. In response to a successful authentication and authorization of a client device 120 (e.g., a first client device 120-11), the PAN manager 160 may also be configured to transmit an authorization message to the computer networking device 110/130 to which the client device 120 is connected (e.g., the first access point 110-11), which may indicate that the client device 120 is to be given access to the MDU network, and also provide the computer networking device 110/130 an indication of whether the client device is a local client device or a remote client device. FIG. 3 shows the PAN manager 160 as a standalone component in communication with the network edge device 190, but in some embodiments the PAN manager 160 may be implemented as part of the network edge device 190 or as part of the controller 170.

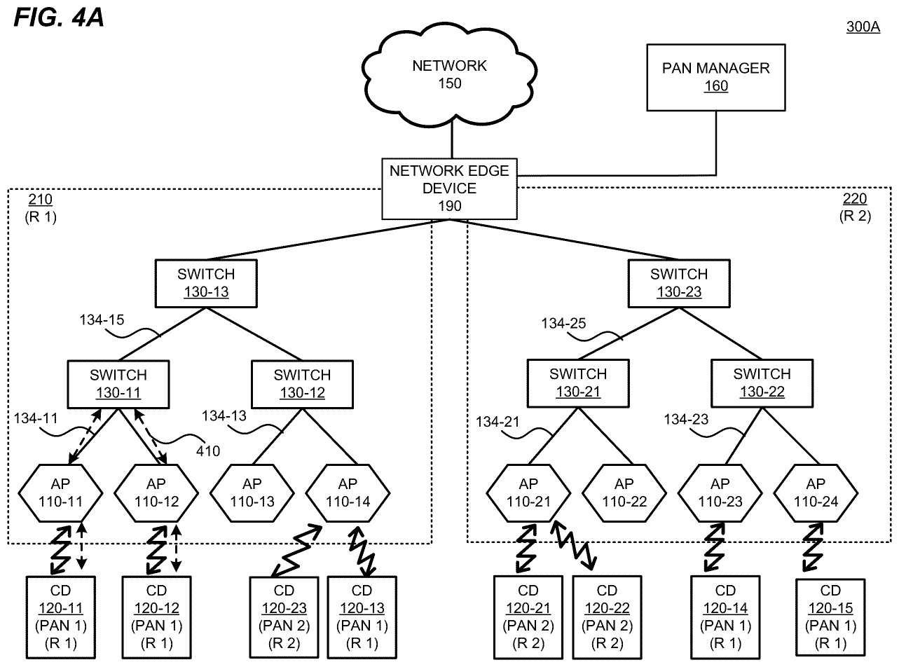

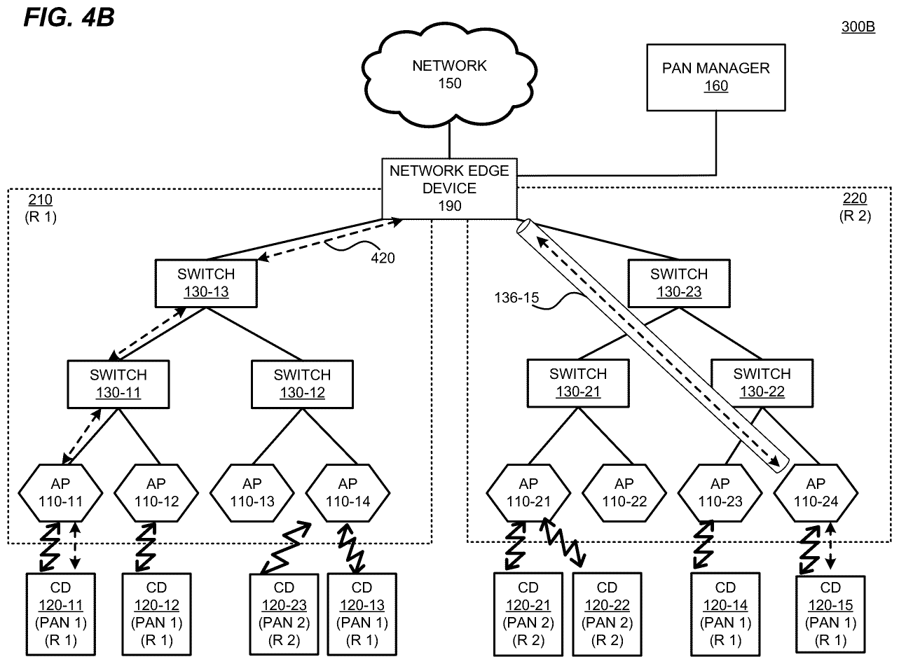

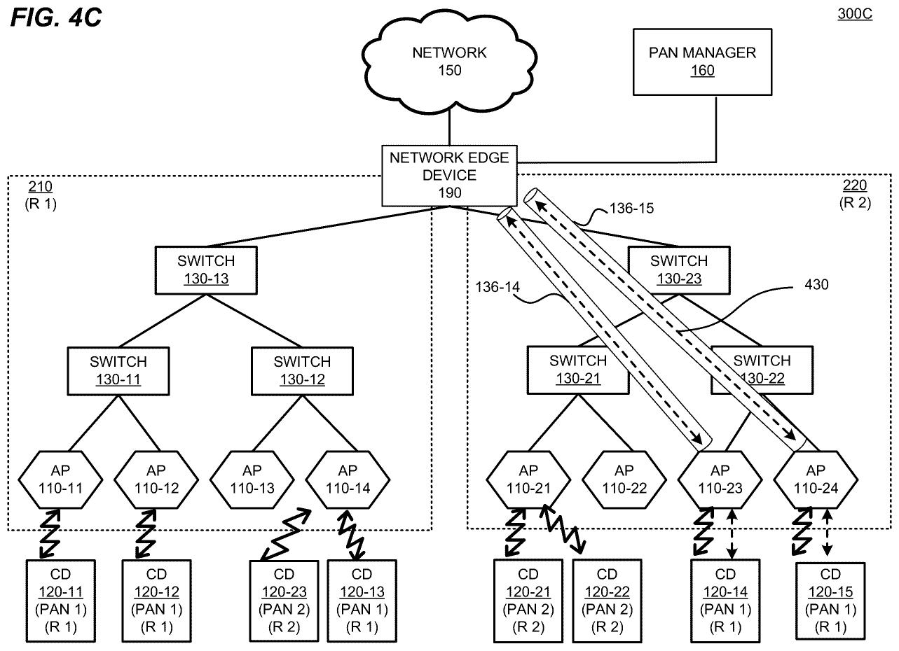

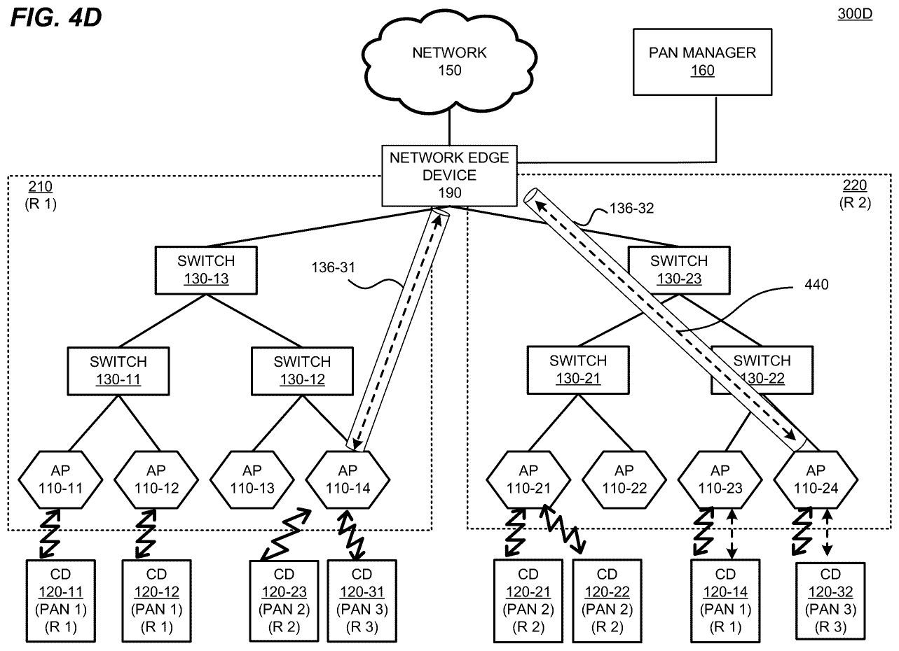

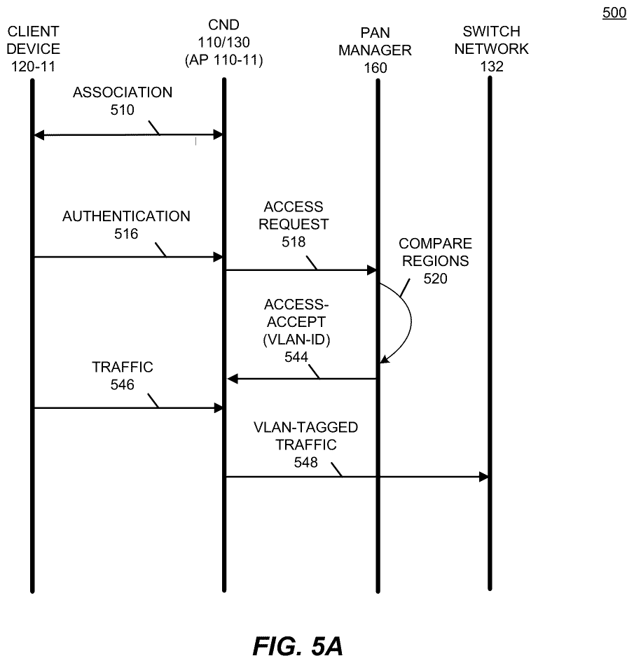

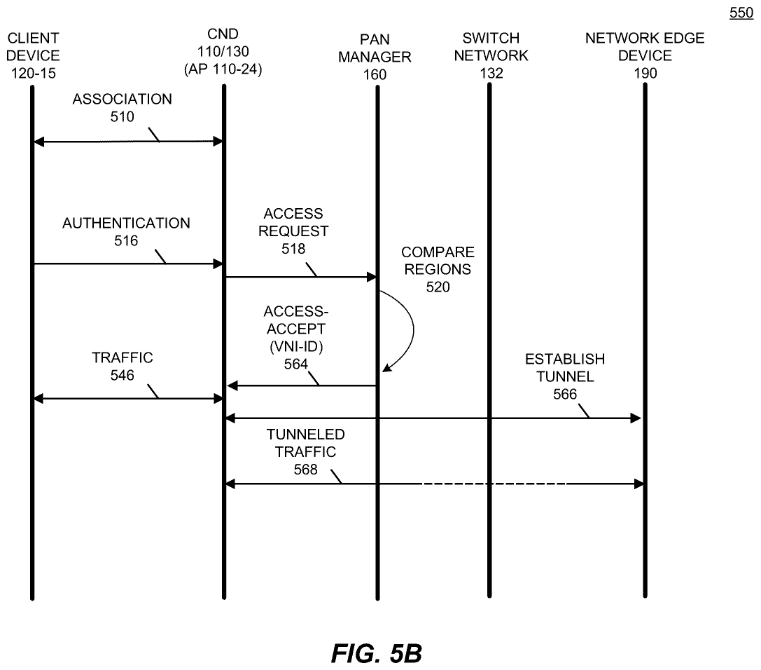

FIGS. 4A to 4D are block diagrams illustrating how traffic can be selectively switched locally or tunneled to a network edge device 190, providing segmentation in a MDU network. FIGS. 5A and 5B are communication flow diagrams illustrating how a computer networking device 110/130 may identify whether a client device 120 serviced by the computer networking device 110/130 is a local client device or remote client device and direct network traffic from the client device 120 accordingly. In FIG. 4A, a MDU network 300A may be handling PAN traffic 410 that is between first and second client devices 120-11 and 120-12 for a first tenant of the MDU, and accordingly associated with a first PAN (PAN 1). The first PAN may be assigned to the first region 210. The first and second client devices 120-11 and 120-12 may be respectively connected to first and second access points 110-11 and 110-12, both of which are configured to provide service within the first region 210.

Prior to the communication of the PAN traffic 410, each access point 110-11 and 110-12 may identify (or may have already identified) whether the respective client device 120-11 and 120-12 is a local client device or a remote client device. In some embodiments, this identification is performed responsive to establishment of a wireless connection between the access point 110-11 and the client device 120-11.

In greater detail and with reference to FIG. 5A, the first client device 120-11 may send a request to join a wireless network (e.g., the MDU wireless network) and associate with the first access point 110-11, and the first access point 110-11 may respond to the request for association with an association response (communication 510). Subsequent to the association of the first client device 120-11 with the first access point 110-11, the first access point 110-11 may instruct or request that the first client device 120-11 authenticate using an authentication protocol, such as IEEE 802.1X. The first client device 120-11 may provide authentication credentials to the PAN manager 160 via the first access point 110-11 (communications 516, 518). In some embodiments, the first client device 120-11 may provide authentication credentials, such as a username and password, DPSK, or the like, to the first access point 110-11 (communication 516). The first access point 110-11 may transmit an access request message (e.g., a RADIUS Access-Request message) to the PAN manager 160 (communication 518). In some embodiments, the first client device 120-11 may establish an authentication tunnel with the PAN manager 160 and provide the authentication credentials to the PAN manager 160 via the authentication tunnel. In some embodiments, the PAN manager 160 may transmit a challenge request to the first client device 120-11 as part of an authentication process, and the first client device 120-11 may transmit a response to the challenge.

The PAN manager 160 may identify the first client device 120-11 and the PAN associated with the first client device 120-11. For example, the first client device 120-11 may be identified using the MAC address of the first client device 120-11, and the MAC address may be used as a lookup value to select a PAN from a table of mappings between MAC addresses and PANs. As another example, the username provided by the first client device 120-11 may be used as a lookup value to select a PAN from a table of mappings between usernames and PANs. As another example, the DPSK provided by the first client device 120-11 may be used as a lookup value to select a PAN from a table of mappings between DPSKs and PANs. Once the PAN associated with the first client device 120-11 is identified, the PAN manager 160 may identify the region to which the PAN is assigned (e.g., using a different lookup table or function).

The PAN manager 160 may also identify the first access point 110-11 that transmitted the access request message, and may identify the region that has the first access point 110-11 as a member. The PAN manager 160 may compare the region of the first access point 110-11 with the region of the first client device 120-11 (operation 520). As the region of the first access point 110-11 matches the region of the first client device 120-11, the first client device 120-11 may be considered to be connected to its local region, and traffic to and from the first client device 120-11 may be switched by the switch network 132 using the first mechanism (e.g., the VLAN tagging mechanism).

The PAN manager 160 may identify the VLAN identifier for the PAN associated with the first client device 120-11. The PAN manager 160 may transmit an authorization message to the first access point 110-11 to which the first client device 120-11 is connected, which may indicate that the first client device 120-11 is to be given access to the MDU network, and also provide the first access point 110-11 with the VLAN identifier (communication 544). Based on the communication from the PAN manager 160, the first access point 110-11 may identify that the first client device 120-11 is a local client device. Traffic from the first client device 120-11 may be received at the first access point 110-11 (communication 546), and is tagged by the first access point 110-11. The VLAN-tagged traffic is then communicated in the switch network 132.

Returning to FIG. 4A, the second client device 120-12 and the second access point 110-12 may also establish communication therebetween, and the second access point 110-12 may identify that the second client device 120-12 is a local client device. Accordingly, PAN traffic 410 between the first and second client devices 120-11 and 120-12 is handled and directed by the switch network 132, and namely switch 130-11 to which the first and second access points 110-11 and 110-12. Although not shown, VLAN tagging and intra-region handling would also occur for PAN traffic from the third client device 120-13 connected to the fourth access point 110-14. Accordingly, PAN traffic 420 between the first and second client devices 120-11 and 120-12 is handled and directed by the MDU network 300A in an efficient manner.

In FIG. 4B, a MDU network 300B may be handling PAN traffic 420 that is between first and fifth client devices 120-11 and 120-15 for a first tenant of the MDU, and accordingly associated with a first PAN (PAN 1). The first PAN may be assigned to the first region 210. The first and fifth client devices 120-11 and 120-15 may be respectively connected to different access points, namely the first access point 110-11 and an eighth access point 110-24. The first access point 110-11 is a member of the first region 210, and the eighth access point 110-24 is a member of the second region 220.

Prior to the communication of the PAN traffic 420, each access point 110-11 and 110-24 may identify (or may have already identified) whether the client device 120-11 and 120-15 connected thereto is a local client device or a remote client device. As the first client device 120-11 is associated with the first PAN, which is assigned to the first region, and as the first client device 120-11 is connected to the first access point 110-11, which is a member of the first region 210, reference is made to FIG. 5A and the previously-provided discussion of identifying a client device that is connected to its local region.

Referring to FIG. 5B, the fifth client device 120-15 may associate with the eighth access point 110-24 (communication 510), and the fifth client device 120-15, the eighth access point 110-24 and the PAN manager 160 may communicate as part of an authentication and access request process (communications 516, 518). Reference is made to the previously-provided discussion communications 510, 516, and 518 of FIG. 5A. Additionally, the PAN manager 160 may identify the fifth client device 120-15, the PAN associated with the fifth client device 120-15, and the region to which the PAN is assigned, using the identification processes discussed with reference to FIG. 5A. The PAN manager 160 may also identify the eighth access point 110-24 and the region that has the eighth access point 110-24 as a member.

The PAN manager 160 may compare the region of the eighth access point 110-24 with the region of the fifth client device 120-15 (operation 520). As the region of the first access point 110-11 does not match the region of the first client device 120-11, the first client device 120-11 may be considered to be connected to a remote region, and traffic to and from the first client device 120-11 may be switched by the switch network 132 using the second mechanism (e.g., a tunnelling mechanism).

The PAN manager 160 may generate a tunnel identifier (VNI) for the fifth client 120-15, and may associate the tunnel identifier with the PAN and/or with the fifth client device 120-15. In some embodiments, the PAN manager 160 may include a many-to-one association table between second switching mechanism identifiers (VNI identifiers) and first switching mechanism identifiers (VLAN identifiers). In some embodiments, the PAN manager 160 may include a many-to-one association table between identifiers used with client devices of a PAN that are connected to remote regions and an identifier used with client devices of a PAN that are connected to a local region.

The PAN manager 160 may transmit an authorization message to the eighth access point 110-24 to which the fifth client device 120-15 is connected, which may indicate that the fifth client device 120 is to be given access to the MDU network, and also provide the first access point 110-11 with the VNI identifier (communication 564). Based on the communication from the PAN manager 160, the eighth access point 110-24 may identify that the fifth client device 120-15 is a remote client device.

The eighth access point 110-24 may establish a tunnel (tunnel 136-15 of FIG. 4B) with the network edge device 190 that has as an identifier the VNI identifier provided by the PAN manager 160 (communication 566). Traffic from the fifth client device 120-15 may be received at the eighth access point 110-24 (communication 546), and may be encapsulated by the eighth access point 110-24 for communication via the established communication tunnel. For example, the traffic may be tagged with the VNI identifier. The VNI-tagged traffic is then communicated in the switch network 132 to the network edge device 190 (communication 568).

In some embodiments, a tunnel identifier or VNI may be reused for multiple client devices 120 of a PAN, and the network edge device 190 may act as an aggregator for all tunnels 136 using the same tunnel identifier or VNI. For example, a first tunnel identifier or VNI may be used for communications between a first access point 110-11 (and one or more client devices 120 associated with a first PAN) and the network edge device 190, and the same first tunnel identifier or VNI may be used for communications between a second access point 110-12 (and one or more client devices 120 associated with the first PAN) and the network edge device 190. In some embodiments, two or more client devices 120 connected to the same access point 110 may use the same established tunnel.

Returning to FIG. 4B, PAN traffic 420 from the first client device 120-11 destined for the fifth client device 120-15 may be communicated via the switch network 132 (and more specifically, the switches 130 that are members of the first region 210) to the network edge device 190, which may serve as the bridge between the first region 210 and the second region 220. The network edge device 190 may identify the destination for the PAN traffic 420 as the fifth client device 120-15, and may encapsulate the PAN traffic for communication via the established communication tunnel 136-15. PAN traffic 420 from the fifth client device 120-15 destined for the first client device 120-11 may be communicated via the established communication tunnel 136-15 over the switch network 132 to the network edge device 190. The network edge device 190 may identify the destination for the PAN traffic 420 as the first client device 120-11, and may tag the PAN traffic with the first switching mechanism identifier (the VLAN identifier associated with the first PAN) for communication via the switches 130 that are members of the first region 210. Accordingly, PAN traffic 420 between the first and fifth client devices 120-11 and 120-15 is handled and directed by the MDU network 300B in an efficient manner.

In FIG. 4C, a MDU network 300C may be handling PAN traffic 430 that is between fourth and fifth client devices 120-14 and 120-15 for a first tenant of the MDU, and accordingly associated with a first PAN (PAN 1). The first PAN may be assigned to the first region 210. The fourth and fifth client devices 120-14 and 120-15 may be respectively connected to different access points, namely a seventh access point 110-23 and the eighth access point 110-24. Both the seventh access point 110-23 and the eighth access point 110-24 are members of the second region 220. Accordingly, both the fourth and fifth client devices 120-14 and 120-15 are connected to a remote region (second region 220). Each of the access points 110-23 and 110-24 may identify (or may have already identified) that the client devices 120-14 and 120-15 connected thereto are remote client devices. Reference is made to FIG. 5B and the previously-provided discussion of identifying a client device that is connected to a remote region.

Based on the indication that the fourth client device 120-14 is a remote client device, the seventh access point 110-23 may establish a communication tunnel 136-14. Based on the indication that the fifth client device 120-15 is a remote client device, the eighth access point 110-24 may establish a communication tunnel 136-15. PAN traffic 430 from the fourth client device 120-14 destined for the fifth client device 120-15 may be communicated from the seventh access point 110-23 to the network edge device 190 via the tunnel 136-14 and from the network edge device 190 to the eighth access point 110-24 via the tunnel 136-15. PAN traffic 430 from the fifth client device 120-15 destined for the fourth client device 120-14 may be communicated via the tunnels 136-15 and 136-14 in a similar way. Accordingly, PAN traffic 430 between the fourth and fifth client devices 120-14 and 120-15 is handled and directed by the MDU network 300C in an efficient manner.

As the number of regions is not limited by the present disclosure to any particular number, there may be instances in which PAN traffic is communicated to or between a plurality of devices that are connected to different remote regions. In FIG. 4D, a MDU network 300D may be handling PAN traffic 440 that is between first and second client devices 120-31 and 120-32 for a third tenant of the MDU, and accordingly associated with a third PAN (PAN 3). The third PAN may be assigned to a third region (not shown). The first and second client devices 120-31 and 120-32 may be respectively connected to different access points, namely a fourth access point 110-14 that is a member of the first region 210 and the eighth access point 110-24 that is a member of the second region 220. Each of the access points 110-14 and 110-24 may identify (or may have already identified) that the client devices 120-31 and 120-32 connected thereto are remote client devices. Reference is made to FIG. 5B and the previously-provided discussion of identifying a client device that is connected to a remote region. Based on the indication that the first client device 120-31 is a remote client device, the fourth access point 110-14 may establish a communication tunnel 136-31. Based on the indication that the second client device 120-32 is a remote client device, the eighth access point 110-24 may establish a communication tunnel 136-32. PAN traffic 440 between the first and second client devices 120-31 and 120-32 may be communicated via the established communication tunnels 136-31 and 136-32. Accordingly, inter-region PAN traffic 440 between the first and second client devices 120-31 and 120-32 is handled and directed by the MDU network 300D in an efficient manner.

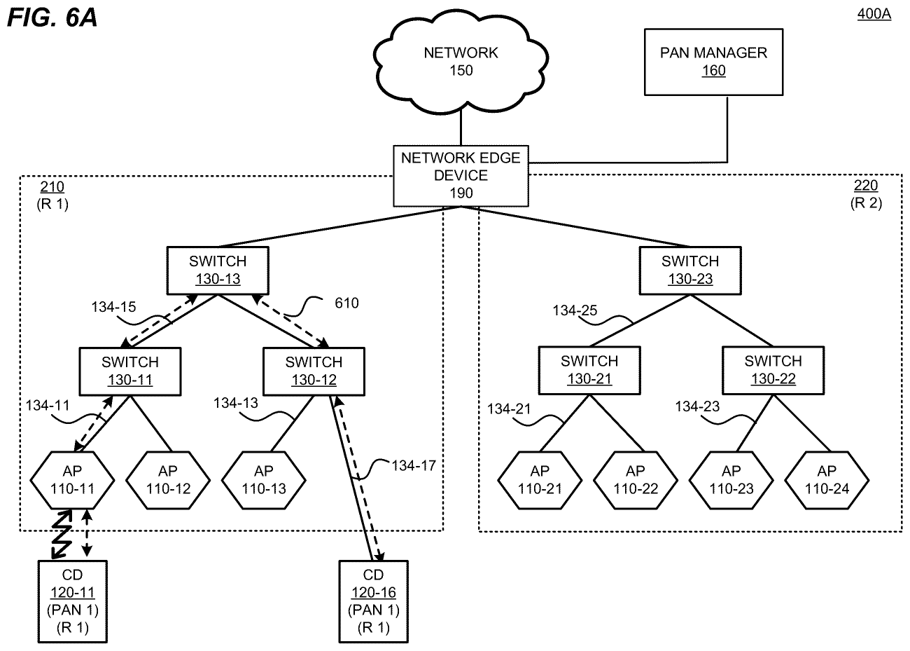

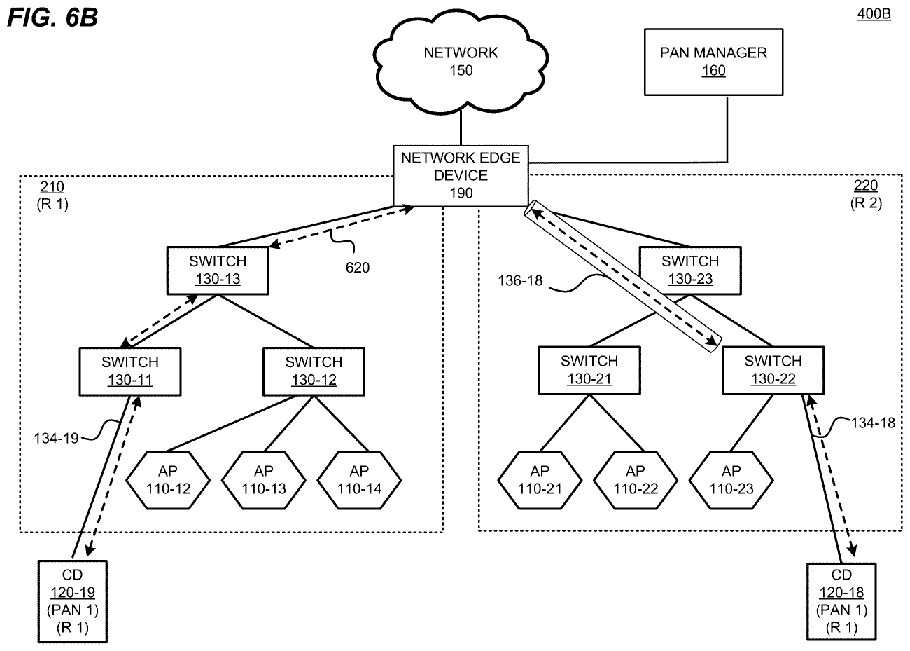

FIGS. 6A and 6B are block diagrams illustrating how traffic can be selectively switched locally or tunneled to a network edge device, providing segmentation in a MDU network. In particular, FIGS. 6A and 6B contemplate that some client devices 120 may be coupled directly to the switch network (e.g., switch 130-21 of FIG. 6A) via a wired connection. Accordingly, and with reference to FIGS. 5A and 5B, in some embodiments the switches 130 may be configured to identify whether a client device 120 that is directly connected to and serviced by the switch 130 is a local client device or remote client device and direct network traffic from the client device 120 accordingly.

In FIG. 6A, a MDU network 400A may be handling PAN traffic 610 that is between first and sixth client devices 120-11 and 120-16 for a first tenant of the MDU, and accordingly associated with a first PAN (PAN 1). The first PAN may be assigned to the first region 210. The first client device 120-11 may be coupled to the first access point 110-11, and the sixth client device 120-16 may be directly coupled to a second switch 130-12. The first access point 110-11 and second switch 130-12 may be members of the first region 210. The first access point 110-11 and the second switch 130-12 may identify (or may have already identified) that the client devices 120-11 and 120-16 connected thereto are local client devices. Reference is made to FIG. 5A and the previously-provided discussion of identifying a client device that is connected to a local region. Based on the indication that the first client device 120-11 is a local client device, the first access point 110-11 may receive traffic from the first client device 120-11 and tag the traffic using the first switching mechanism identifier (VLAN identifier) provided by the PAN manager 160. The tagged traffic is then communicated in the switch network 132. Similarly, based on the indication that the sixth client device 120-16 is a local client device, the second switch 130-12 may receive traffic from the sixth client device 120-16 and tag the traffic using the first switching mechanism identifier (VLAN identifier) provided by the PAN manager 160. The tagged traffic is then communicated in the switch network 132.

In FIG. 6B, a MDU network 400B may be handling PAN traffic 620 that is between eighth and ninth client devices 120-18 and 120-19 for a first tenant of the MDU, and accordingly associated with a first PAN (PAN 1). The first PAN may be assigned to the first region 210. The ninth client device 120-19 may be coupled to a first switch 130-11 that is a member of the first region 210. The eighth client device 120-18 may be coupled to a fourth switch 130-22 that is a member of the second region 220. The first and fourth switches 130-11, 130-14 may identify (or may have already identified) that the client devices 120-18 and 120-19 connected thereto are local or remote client devices, as described with reference to FIGS. 5A and 5B.

Based on the indication that the ninth client device 120-19 is a local client device, the first switch 130-11 may receive traffic from the ninth client device 120-19 and tag the traffic using the first switching mechanism identifier (VLAN identifier) provided by the PAN manager 160. The tagged traffic is then communicated in the switch network 132 to the network edge device 190. Based on the indication that the eighth client device 120-18 is a remote client device, the fourth switch 130-22 may establish a communication tunnel 136-18 with the network edge device 190, tag traffic from the eighth client device 120-18 with a second switching mechanism identifier (VNI identifier) and may communicate the tagged traffic for the eighth client device 120-18 via the established communication tunnel 136-18.

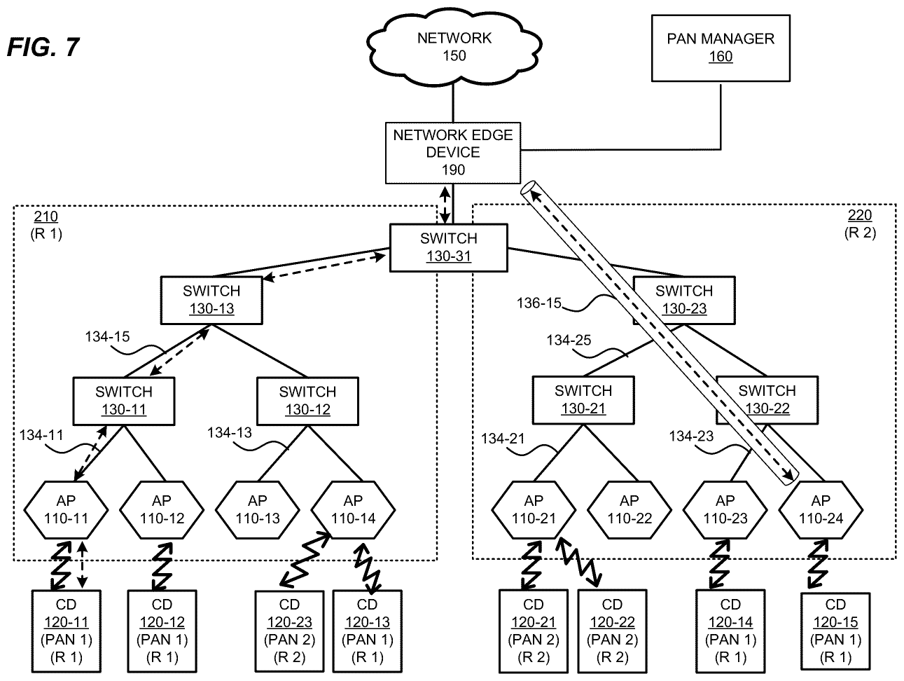

FIG. 7 is a block diagram illustrating how traffic can be selectively switched locally or tunneled to a network edge device, providing segmentation in a MDU network. FIG. 7 shows that in some embodiments, some switches 130 that are part of the switch network 132 may service two or more regions 210, 220. For example, a switch 130-31 may be a distribution switch that provides service to the first region 210 and the second region 220. The distribution switch 130-31 may be configured in a similar manner to the other switches of the switch network 132.

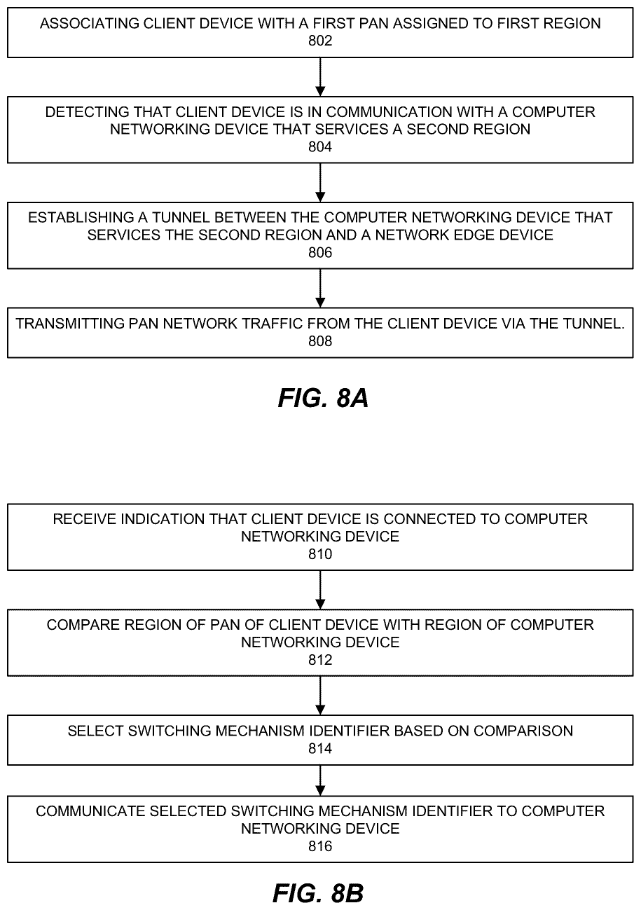

FIG. 8A is a flowchart detailing operations in a method of handling traffic from a client device serviced by a computer networking device that is a member of a region that is different from a region of the client device. As seen in FIG. 8A, a method may include associating a first client device with a first personal area network (PAN), wherein the first PAN is assigned to a first region from a plurality of regions (block 802); detecting that the first client device is in communication with a computer networking device that services a second region from the plurality of regions (block 804); establishing a tunnel between the computer networking device that services the second region and a network edge device (block 806); and transmitting, via the established tunnel, first PAN network traffic received at the network edge device and directed to the first client device (block 808).

FIG. 8B is a flowchart detailing operations in a method of identifying whether a client device serviced by a computer networking device is a local client device or remote client device and directing network traffic from the client device based on the identification. As seen in FIG. 8B, a method may include receiving an indication that a client device is in communication with a computer networking device (block 810); comparing a region of the computer networking device with a region of the client device (block 812); selecting a switching mechanism identifier based on the comparison (block 814), and communicating the selected switching mechanism identifier to the computer networking device (block 816). In some embodiments, selecting the switching mechanism identifier may include selecting, in response to identifying that the computer networking device is a member of the same region as the client device, a first identifier, and selecting, in response to identifying that the computer networking device provides service to a different region, a second identifier. In some embodiments, communicating the selected switching mechanism identifier to the computer networking device may include selecting the selected one of the first identifier and the second identifier to the computer networking device. The computer networking device may be configured to tag PAN network traffic from the client device using the communicated one of the first identifier and the second identifier.

In some embodiments, a PAN may be assigned to a region based on an operation of an administrator or a user. For example, as part of an initial onboarding process, an administrator may identify a ‘home’ or ‘base’ location for a tenant, and a PAN for the tenant may be assigned with a region based on the physical location in the MDU of the home location or base location. As another example, a hotel registration system may indicate to the PAN manager 160 that a hotel room has been assigned to a hotel guest, and the PAN manager 160 may assign (and/or reassign) a PAN of the hotel guest to a region based on the location of the hotel room. In some embodiments, a PAN of an MDU tenant may be assigned to a region based on the access point 110 or switch 130 with which a first client device 120 of the tenant first communicates.

In some embodiments, a PAN for a MDU tenant may not initially be assigned to a region, and the PAN manager 160 may be configured to identify, using network data, the region to which the PAN of the tenant should be assigned. In some embodiments, a PAN for a MDU tenant may initially be assigned to a first region, and the PAN manager 160 may be configured to identify, using network data, a second region to which the PAN of the tenant should be re-assigned. FIGS. 9A and 9B are block diagrams of a network 900 illustrating how the PAN manager 160 may automatically or programmatically identify a region to which the PAN of a MDU tenant should be assigned. FIG. 10 is a flowchart detailing operations in a method of assigning (or reassigning) a PAN to a region based on network usage details.

In FIG. 9A, a PAN (PAN 1) for a first tenant is not yet assigned to a region, and network traffic for each of the client devices 120-11, 120-12, 120-13, 120-14, and 120-15 is tunneled between a network edge device 190 and a switch 130 or an access point 110 to which the client device 120 is connected (block 1010 of FIG. 10). For example, seen in FIG. 9A, the network traffic between a first client device 120-11, a second client device 120-12, a fourth client device 120-14, and a fifth client device 120-15 may be communicated via respective tunnels 136-11, 136-12, 136-14, and 136-15 between the switch (e.g., switch 130-11) or the access point (e.g., access points 110-11, 110-23, 110-24) that is connected with the corresponding client device 120. In other words, in a state in which a PAN is not assigned to a region, the network 900 may operate similarly to the network 200 described with reference to FIG. 2.

In some embodiments, the computer networking devices 110/130 and/or the network edge device 190 may transmit network usage details to the PAN manager 160. For example, the computer networking devices 110/130 or the network edge device 190 may transmit details about client devices 120, such as a device type (e.g., laptop, smartphone, desktop, printer) of each client device 120. The computer networking devices 110/130 or the network edge device 190 may transmit an indication of an amount of data that is being transmitted to and from each client device 120. The computer networking devices 110/130 or the network edge device 190 may transmit details (e.g., a location) about the switch 130 or the access point 110 to which the client device 120 is connected and that is serving as a tunnel endpoint for a communication tunnel 136.

The computer networking devices 110/130 or network edge device 190 may transmit details about the mobility (and/or lack of mobility) of a client device 120. For example, some client devices 120 (such as televisions, gaming consoles, smart appliances, and so on) may be relatively immobile and may be connected to a same access point 110 or switch 130, or to a relatively small number of access points 110 or switches 130. On the other hand, mobile devices such as smartphones, tablets, and laptop computers may move throughout the MDU, and may connect to a number of access points 110 or switches 130 through the MDU.

Based on the transmitted network usage details, the PAN manager 160 may identify a region for the PAN (block 1012) and may assign the PAN for the MDU tenant to the identified region (block 1014). For example, the assignment of the PAN to a region may be based on a type, number, and location of less-mobile devices that are frequently connected to a small number of or single access points 110 and/or switches 130. In some embodiments, the network usage details may be collected for a period of time (e.g., a week, a month), and network usage patterns may be detected. The assignment of the PAN may be based on the detected network usage patterns. For example, client devices 120 of a PAN may connect frequently during non-business hours to a single access point 110, potentially indicating a location at which a tenant is during non-working hours (e.g., their home). In some embodiments, various factors or parameters may be identified and weights may be given to the device type and device location, the home location of customer can be identified.

After the PAN is assigned to the region, traffic for client devices may be directed based on whether the client device is connected to an access point 110 or switch 130 that is a member of the assigned region (block 1016). This may include using the devices, systems, and methods described above with respect to FIGS. 1 and 3-8B. In FIG. 9B, the PAN (PAN 1) for a first tenant is assigned to the first region, and network traffic for each of the client devices 120-14, and 120-15 is tunneled between a network edge device 190 and a switch 130 or an access point 110 in the second region 220 to which the client device 120-14, 120-15 is connected, while traffic from each of the client devices 120-11, 120-12, and 120-13 (which are connected to the first region 210) is locally switched and directed by the access points 110 and switches 130 that are members of the first region 210.

It is recognized that in some instances, creation and tearing down of tunnels 136 (e.g., VxLAN tunnels) established for carrying user traffic may create a processing burden on the network edge device 190. For example, the network edge device 190 may be a software-based device which may not have hardware for data packet forwarding, and processors of the network edge device 190 may be used for data plane, control plane, and management plane traffic. As a first client device 120-21 moves from a coverage area of a first access point 110-11 in a remote region and associates with a second access point 110-12 in the remote region, the tearing down of a first tunnel between the first access point 110-11 and the network edge device 190, and the establishing of a second tunnel between the second access point 110-12 and the network edge device 190 may impact performance and data plane forwarding at the network edge device 190. Additionally, any traffic from the client device 120-21 may be queued or delayed until the tunnel 136 is created, creating loss or jitter.

Accordingly, in some embodiments, explicit teardown of tunnels (using e.g., control plane messaging) may be disabled, and timeouts of established tunnels 136 may be set to a long time period (e.g., 1 week or more). The timeout may be extended when each tunnel 136 is used. Thus, a client device 120 that regularly or repeatedly connects to a remote-region access point 110 may be able to use an already-established tunnel 136 for the client device 120 (or the PAN thereof) between the remote-region access point 110 and the network edge 190, once a client device 120 initially connects the remote region access point 110 and the tunnel 136 is initially established.

It is noted that the use of long-timeout tunnels is not limited to the region-based MDU networks provided herein, and may be used in networks according to FIG. 2, such as those where segmentation is provided by tunneling all PAN traffic to the network edge device 190.

In some embodiments, control plane mechanisms, such as EVPN (Ethernet Virtual Private Network) can also be deployed. Using EVPN as the control plane of VXLAN can enable Virtual Tunnel End Points (VTEPs) to be discovered and VXLAN tunnels to be established, simplifying network deployment and expansion, and potentially reducing flooding traffic on the network. EVPN uses BGP (Border Gateway Protocol) formatted information to exchange endpoint device MAC and IP address information for VTEPs. This may permit a MAC address (associated with a client device 120) to move from one location in the network to another location in the network or data center relatively easily (for example because the VM is moved from one bare-metal server to another). More broadly speaking, these control plane mechanisms may be a way to track MAC address mobility.

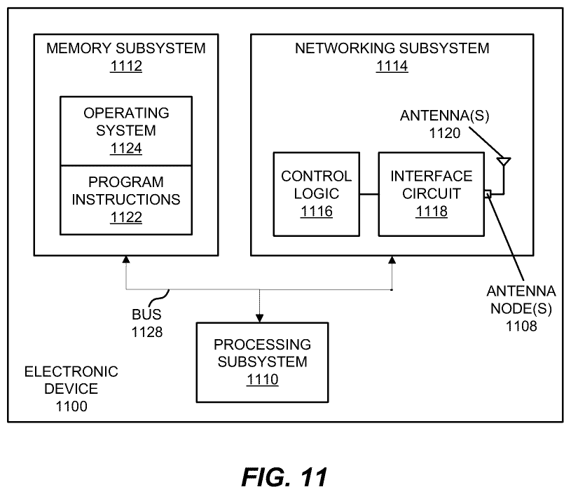

FIG. 11 is a block diagram illustrating an electronic device 1100 in accordance with some embodiments. The electronic device 1100 may be, for example, one of the access points, switches, client devices, PAN manager, network edge device, controller or other devices of the networks described above. The electronic device 1100 includes a processing subsystem 1110, a memory subsystem 1112, and a networking subsystem 1114. Processing subsystem 1110 includes one or more devices configured to perform computational operations. Memory subsystem 1112 includes one or more devices for storing data and/or instructions. In some embodiments, the instructions may include an operating system and one or more program modules which may be executed by processing subsystem 1110.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). While FIG. 11 includes an antenna 1120, in some embodiments electronic device 1100 includes one or more nodes, such as nodes 1108, e.g., a connector, which can be coupled to one or more antennas 1120 that are external to the electronic device 1100. Thus, electronic device 1100 may or may not include the one or more antennas 1120. Networking subsystem 1114 includes at least a networking system based on the standards described in IEEE 802.11 (e.g., a Wi-Fi networking system).

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1100 may use the mechanisms in networking subsystem 1114 for performing simple wireless communication between the electronic devices, e.g., transmitting frames and/or scanning for frames transmitted by other electronic devices.

Processing subsystem 1110, memory subsystem 1112, and networking subsystem 1114 are coupled together using bus 1128. Bus 1128 may include an electrical, optical, and/or electro-optical connection that the subsystems can use to communicate commands and data among one another.

Electronic device 1100 can be (or can be included in) any electronic device with at least one network interface. For example, electronic device 1100 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

The operations performed in the communication techniques according to embodiments of the present inventive concepts may be implemented in hardware or software, and in a wide variety of configurations and architectures. For example, at least some of the operations in the communication techniques may be implemented using program instructions 1122, operating system 1124 (such as a driver for interface circuit 1118) or in firmware in interface circuit 1118. Alternatively or additionally, at least some of the operations in the communication techniques may be implemented in a physical layer, such as hardware in interface circuit 1118.

Embodiments of the present inventive concepts have been described above with reference to the accompanying drawings, in which embodiments of the inventive concepts are shown. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed is:

1. A method comprising:
establishing a wireless connection between an access point and a client device, where the access point is configured to service a first region from a plurality of regions;
identifying, by the access point, that the client device is a member of a first personal area network (PAN) associated with a second region from the plurality of regions;
establishing, by the access point and in response to the identifying, a network tunnel between the access point and a gateway device; and
communicating first PAN traffic for the client device via the established network tunnel.

2. The method of claim 1, wherein the access point is configured to identify that the client device is a member of the first PAN based on a message received from an authentication and authorization server.

3. The method of claim 2, wherein the message is an access acceptance message indicating that the client device is authorized to access a network via the access point.

4. The method of claim 2, wherein the message includes an identifier, and wherein the access point is configured to associate the first PAN traffic with the identifier.

5. The method of claim 4, wherein the access point is configured to encapsulate the first PAN traffic in a data unit that comprises the identifier.

6. The method of claim 4, wherein the identifier is a virtual network identifier (VNI).

7. A method comprising:
associating a first client device with a first personal area network (PAN), wherein the first PAN is assigned to a first region from a plurality of regions;
detecting that the first client device is in communication with a computer networking device that services a second region from the plurality of regions;
establishing a tunnel between the computer networking device that services the second region and a network edge device; and
transmitting, via the established tunnel, first PAN network traffic received at the network edge device and directed to the first client device.

8. The method of claim 7, further comprising transmitting, via the established tunnel, second PAN network traffic received at the computer networking device and directed to a second client device associated with the first PAN.

9. The method of claim 7, wherein the computer networking device is configured to establish the tunnel with the network edge device based on a message received from an authentication and authorization server.

10. The method of claim 9, wherein the message is an access acceptance message indicating that the first client device is authorized to access a network via the computer networking device.

11. The method of claim 9, wherein the message includes an identifier, and wherein the computer networking device is configured to associate the first PAN traffic with the identifier.

12. The method of claim 7, wherein the computer networking device is an access point.

13. The method of claim 7, wherein the established tunnel has a timeout period lasting at least one week.

14. A method comprising:
associating a first client device to a first personal area network (PAN), wherein the first PAN is assigned to a first region from a plurality of regions;
receiving an indication that the first client device is in communication with a first computer networking device;
identifying whether the first computer networking device is a member of a plurality of computer networking devices that service the first region;
selecting one of a first identifier or a second identifier, wherein the first identifier is selected in response to identifying that the first computer networking device is a member of the plurality of computer networking devices, and wherein the second identifier is selected in response to identifying that the first computer networking device provides service to a second region different than the first region; and
communicating the selected one of the first identifier and the second identifier to the first computer networking device, wherein the first computer networking device is configured to tag PAN network traffic from the first client device using the communicated selected one of the first identifier and the second identifier.

15. The method of claim 14, wherein the first identifier is a virtual local area network (VLAN) identifier, and the second identifier is a virtual network identifier (VNI).

16. The method of claim 14, wherein the first computer networking device is an access point.

17. The method of claim 14, wherein the first computer networking device is a networking switch.

18. The method of claim 14, wherein the selected one of the first identifier and the second identifier is communicated in an authorization access message indicating that the first client device is authorized to access a network via the first computer networking device.
